(19) United States
(12) Patent Application Publication
(10) Pub. No.: US 2010/0232842 A1
(43) Pub. Date: Sep. 16, 2010

(54) DEVELOPER UNIT FOR AN ELECTROPHOTOGRAPHIC PRINTING DEVICE FOR PRINTING ON GLASS OR CERAMIC MATERIAL

(75) Inventors: Dieter Jung, Daaden (DE); Andreas Schoenberger, Emmerzhausen (DE); Christian Hornickel, Nisterberg (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: AGC Glass Europe, Jumet (BE)

(21) Appl. No.: 12/597,350

(22) PCT Filed: Apr. 10, 2008
(86) PCT No.: PCT/EP08/02811

§ 371 Date: Apr. 5, 2010

(30) Foreign Application Priority Data
Apr. 24, 2007 (EP) 07008283.9

(51) Int. Cl. G03G 15/08

(52) U.S. Cl. 399/287

(57) ABSTRACT

The invention relates to a developer unit for an electrophotographic printing device for printing on glass or ceramic material having a toner supply (30, 32) and a toner application device (38), toner being discharged onto a developer device (18) by means of the toner application device (38) and it being possible for the developer device (18) to be brought into flat contact with a photoconductor (10). According to the invention, the developer device (18) has a fibre coating (19) of electrically conductive fibres, which picks up the toner and is in contact with the photoconductor (10) in order to transfer the toner.

The invention relates to a developer unit for an electrophotographic printing device for printing on glass or ceramic material having a toner supply and a toner application device, toner being discharged onto a developer device by means of the toner application device and it being possible for the developer device to be brought into flat contact with a photoconductor.

Furthermore, the invention relates to an electrophotographic printing device for printing on glass or ceramic material having such a developer unit.

The prior art discloses such developer units in which, because of the intensive mechanical contact between the developer roll, on the one hand, and the photoconductor, the metering roll and the applicator roll, on the other hand, relatively high pressing forces occur. As a result of these pressing forces, at high printing speeds the toner particles are partly melted, smear and form a film-like application. This application can remain on the developer roll or to some extent be transferred to the photoconductor in complete portions of the area. Accordingly, the conventional electrophotographic printing devices can be operated only at relatively low printing speeds.

Because of the intensive mechanical contact between the developer roll and the photoconductor to form a sufficiently large nip for the development, wear often occurs on the two components in the conventional developer units, since speed differences, which cause friction, occur in the boundary regions. The same is true of the points of contact on the applicator roll and the metering roll, particularly since here the direction of rotation must be opposite and a relatively high speed difference is necessary for functional reasons. The wear becomes still considerably higher if functional toner with electric conductivity, ceramic and conductive toners are used, since these toners have an increased abrasive action.

Using a toner particle size of 5-10 μm in the conventional developer units, a one-layer or two-layer toner layer is formed which is only about 8-15 μm thick. In the case of greater layer thicknesses of the non-conductive toner, the potential differences necessary for the development do not act adequately, so that not all the toner particles are transferred to the photoconductor.

The conventional developer units are primarily embodiments for the DIN A3 and DIN A4 formats. Given these relatively small widths, sufficient accuracy of the components such as rolls and photoconductors can still be achieved quite well.

A direct implementation with identical components to a large format of, for example, 36″ width is not readily possible. On account of the diameter tolerances, circular running inaccuracies and sagging, distances and the nip at the photoconductor can change and allow the toner application to become non-uniform.

In the conventional developer units, the toner must be brought to a very high charge of approx 50-100 μC/g in order that the device runs stably. This triboelectric charge must be produced by friction, which arises on the applicator roll. The level of the charge must then be maintained until contact is made between developer roll and photoconductor. These devices are very sensitive to moisture, since the charge can be affected greatly, depending on the prevailing atmospheric humidity.

It is therefore an object of the invention to specify a developer unit for an electrophotographic printing device which avoids the aforementioned problems and supplies a high-quality printed image with little wear.

This object of the invention is achieved by an electrophotographic printing device having the features of Patent claim 1. Advantageous developments of the developer unit according to the invention are described in the subclaims.

Accordingly, the developer device has a fibre coating of electrically conductive fibres, which picks up the toner and is in contact with the photoconductor in order to transfer the toner. Each fibre is able to pick up a plurality of toner particles, so that the toner application can be increased to 30-50 μm, whereas in a conventional single-component system only 10-15 μm can be achieved. Because of the good conductivity of the individual fibres, a plurality of toner particles are deposited on the individual fibres and form an intense, uniform and loose toner flock.

With the single-component developer unit according to the invention, the same or a higher toner layer can be achieved as compared with the case of the classical two-component developer systems which use a toner and a carrier, since the conductive fibres replace the more or less conductive carrier in functional terms.

The developer device can have a developer roll having a roll body to which the fibre coating is applied circumferentially, the roll body being arranged at a distance from the photoconductor which is less than the height of the fibres of the fibre coating projecting from the roll body, and the roll body not making direct contact with the photoconductor. Because of the lack of mechanical contact between the developer roll and the photoconductor, no pressing forces occur, so that the toner particles are not partly melted. A high printing speed can thus be realized. Possible diameter tolerances, circular running inaccuracy and sagging have no effect, since there is no contact between the rolls.

Since, during the entire development process, no mechanical forces act on the toner particles, the proportion of wax can be set in an optimum way to the respective type of fixing. The “smearing and filming” that occur in known single-component systems cannot occur because of the lack of pressure.

A predetermined electric potential or a bias voltage can be applied to the developer roll, in order to set the layer thickness relatively simply and exactly.

In the contact region between the photoconductor and the fibre coating of the developer roll, an indentation or a nip can be formed in the fibre structure of the fibre coating of the developer roll. Because of the lack of mechanical contact between the developer roll and the photoconductor in order to form the sufficiently large nip for the development, considerably less wear occurs on the two components.

The toner application device can have an applicator roll which is arranged at a distance from the roll body of the developer roll which is less than the height of the fibres of the fibre coating projecting from the roll body, the roll body not making direct contact with the applicator roll. Less wear also occurs on the applicator roll, since the contact between the components takes place only via the fibre coating.

In order to transfer the toner from the applicator roll to the developer roll, a predetermined electric potential can be applied to the applicator roll.

To reduce the toner layer thickness, a metering roll can be arranged on the developer roll, being arranged at a distance from the roll body of the developer roll which is less than the height of the fibres of the fibre coating projecting from the roll body, the roll body not making direct contact with the metering roll. Less wear also occurs on the metering roll, since the contact between the components takes place only via the fibre coating.

A predetermined electric potential can be applied to the metering roll in order to remove excess toner.

In the direction of rotation of the developer roll, between the metering roll and the photoconductor, a toner charging corona, which applies additional charge to the toner particles, can be arranged on the developer roll. Since the toner is still charged uniformly by the toner charging corona placed upstream and the potential with respect to the discharged point of the photoconductor is present unambiguously and uniformly because of the high conductivity of the fibre material, a high and uniform layer thickness can be expected during the development.

In the following text, the invention will be explained in more detail by using a preferred embodiment and with reference to the appended figures, in which:

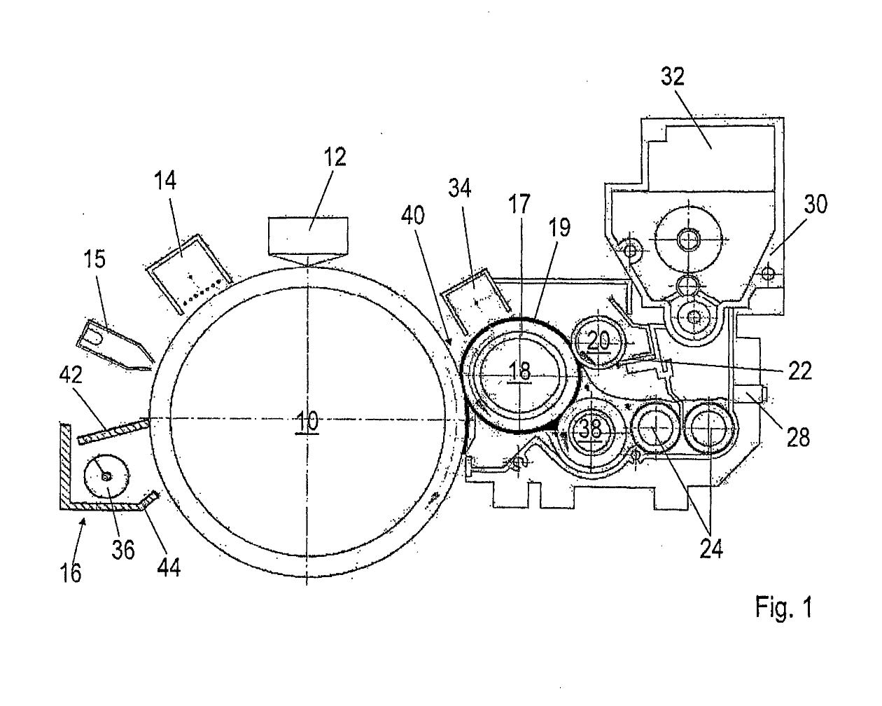

FIG. 1 shows, in schematic view and in section, an embodiment of the electrophotographic printing device for printing on glass or ceramic material according to the invention, and

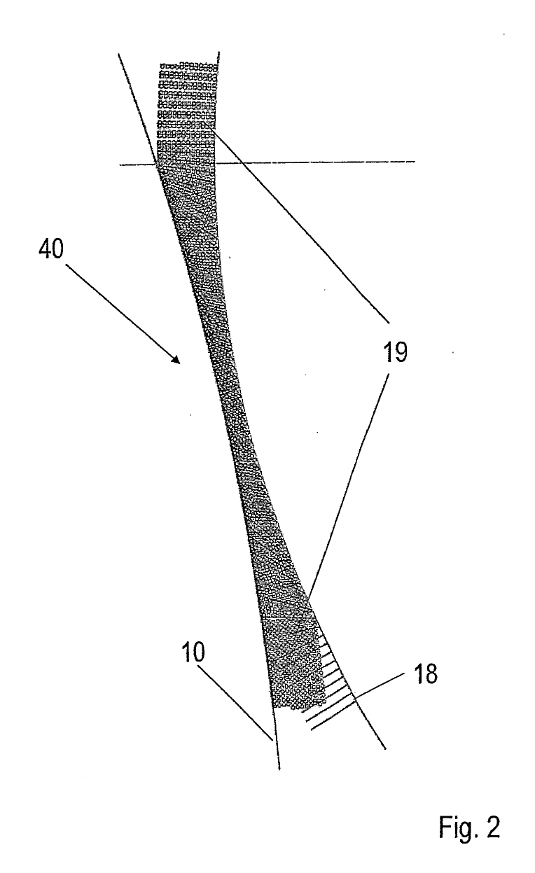

FIG. 2 shows, in schematic view and an enlarged illustration, the contact region in which the photoconductor and the coated developer roll are in contact via the conductive fibres of the coating.

Via a toner attachment 30, which has an incorporated toner supply device (not specifically shown), the toner passes from a toner cartridge 32 into the region of two conveying and mixing screws 24 rotating in opposite directions. A level sensor 28 reports the correct filling level to the electronic controller (not shown) of the printing device. The electronic controller requests new toner as required on the basis of the sensor signal.

The single-circuit system formed by the conveying and mixing screws 24 conveys the toner to an applicator roll 38 rotating in the anticlockwise direction. The applicator roll 38 is predominantly composed of a material which charges up the coating 19 of the developer roll 18 triboelectrically, for example of EPDM, NBR or PU foam. The width of the applicator roll 38 is about 960 mm, the diameter about 50 mm, the Shore hardness A about 50° and the cell size about 200 μm. Via a connection for bias voltage to the inner core axle, a bias voltage of about −600 to −800 VDC can be applied to the applicator roll 38. The applicator roll 38 has a resistance of about 500 kOhm/cm.

As a result of counter-rotation, the applicator roll 38 applies toner to the coated developer roll 18, which rotates in the anticlockwise direction. The ratio of the rotational speed of the coated developer roll 18 to the rotational speed of the applicator roll 38 is 1:0.5. Between the applicator roll 38 and the roll body 17 of the coated developer roll 18, a small gap is set, depending on the height of the fibre coating.

The body of the coated developer roll 18 consists of EPDM, NBR or PU foam and is provided with a fibre coating 19 of carbon fibres, conductive velour or a flock of conductive nylon filaments. The thickness of the fibre coating 19, with which it projects beyond the roll body 17, is about 1 to 2 mm. The width of the coated developer roll 18 is about 960 mm, the diameter of the body is about 50 mm, with a Shore hardness A of about 50°, and the external diameter with fibre coating 19 is about 52-54 mm. Via a connection for bias voltage to the inner core axle, a bias voltage of about −200 to −400 VDC can be applied to the coated developer roll 18, and the latter has a resistance of 500 kOhm/cm to 2 MOhm/cm.

In an alternative embodiment (not shown), instead of a developer roll provided with a fibre coating, a suitable developer belt with an appropriate fibre coating can also be used. The developer belt then runs around over deflection rolls, guided between the applicator roll and the photoconductor.

During application of the toner to the coated developer roll 18, the toner is charged up triboelectrically by friction and adheres to the individual conductive fibres of the coated developer roll 18. Each fibre is able to pick up a plurality of toner particles, so that the result is a toner application of 30-50 μm.

The adhering toner layer is then reduced to the necessary layer thickness via a metering roll 20 rotating in the opposite direction, the anticlockwise direction. The metering roll 20 is substantially composed of a metal tube with a smooth surface or a GRP or CRP tube with a metallized surface and has a connection for bias voltage to the metal tube axle. In this case, a bias voltage of about −250 to −450 VDC can be applied to the metering roll 20. The ratio of the speed of rotation of the coated developer roll 18 to the speed of rotation of the metering roll 20 is about 1:0.5. Between the metering roll 20 and the roll body 17 of the coated developer roll 18, a slight gap is set, depending on the height of the fibre coating.

The charged metering roll 20 lifts the excess toner off the coated developer roll 18. The residual toner is removed by a doctor 22 guided on the outer side of the metering roll 20 and is supplied to the toner circuit again.

The toner particles adhering to the coated developer roll 18 are then given additional charge via a toner charging corona 34 that is arranged on the coated developer roll 18 between the metering roll 20 and the photoconductor 10, in order that there is a uniform and controllable potential on the surface.

The toner is then transferred to the roll-like photoconductor 10 rotating in the clockwise direction, the contact between the photoconductor 10 and the coated developer roll 18 taking place only via the conductive fibres of the coating in the contact region 40, as illustrated schematically in FIG. 2. Direct contact between the roll bodies 17 is avoided. A gap that depends on the fibre length is set between developer roll core and the photoconductor.

In this case, the photoconductor 10 dips about 1 mm into the fibre coating 19 of the coated developer roll 18, so that an indentation in the fibre coating 19 or a nip zone of about 10 mm width is produced between coated developer roll 18 and the photoconductor. Within this nip zone, given an appropriate potential difference, the toner transfer from the conductive fibres to the photoconductor 10 takes place.

In order to control the layer thickness of the toner, the speed ratio between the photoconductor 10 and the coated developer roll 18 of 1:1 to about 1:3 (preferably 1:1.2) is set via an appropriate motor controller (not shown). As a result of the small speed difference which may be present, additional mechanical drift is produced between the coated developer roll 18 and the photoconductor 10. The toner transfer from the coated developer roll 18 to the photoconductor 10 thus takes place at the same or approximately the same peripheral speed, so that no distortions or line broadenings are produced. The abrasive action of the functional or rather conductive toner on the photoconductor 10 does not occur in the event of substantially equal circumferential speeds, so that a higher efficiency is to be expected.

The toner particles not needed for the development are transferred to the applicator roll 38 again by the coated developer roll 18 and supplied to the toner supply again. Provided above the photoconductor 10 is an exposure device 12 having an LED head, which exposes a photosensitive layer of the photoconductor 10 in a known way. In this way, a latent electrostatic image is produced. In the region of the photoconductor that is at the bottom in FIG. 1, the toner particles are transferred to a transfer medium (not shown). Any toner residues still adhering to the photoconductor 10 are removed by means of a cleaning device 16, which follows the lower region.

Arranged on the outer circumference of the photoconductor 10 is a cleaning blade 42, which removes the toner residues and supplies them to a suitable collecting device 44. In the collecting device 44, the particles picked up are collected and trans-ported into a waste container via a suitable old toner screw conveyor 36 or supplied to the toner supply again. An extinguishing light bar 15 following the cleaning device 16 discharges the photosensitive layer of the photoconductor. This photosensitive layer is then brought to a uniform charge structure again by means of a charging corona 14 following the extinguishing light bar 15, so that the photoconductor 10 can be provided with an electrostatic charge image again by the following exposure device 12.

1. A developer unit for an electrophotographic printing device for printing on glass or ceramic material wherein the developer unit has a toner supply and a toner application device; a toner is discharged onto a developer device by the toner application device the developer device is in flat contact with a photoconductor;
the developer device has a fibre coating of electrically conductive fibre; and the developer device picks up the toner and is in contact with the photoconductor to transfer the toner.

2. The developer unit according to claim 1,
wherein
the developer device has a developer roll having a roll body to which the fibre coating is applied circumferentially, the roll body being arranged at a distance from the photoconductor which is less than a height of fibres of the fibre coating projecting from the roll body, and the roll body not making direct contact with the photoconductor.

3. The developer unit according to claim 2,
wherein
a predetermined electric potential is applied to the developer roll.

4. The developer unit according to claim 2,
wherein
in a contact region between the photoconductor and the fibre coating of the developer roll, an indentation or a nip is formed in the fibre structure of the fibre coating of the developer roll.

5. The developer unit according to claim 2,
wherein
the toner application device has an applicator roll which is arranged at a distance from the roll body of the developer roll which is less than the height of the fibres of the fibre coating projecting from the roll body, the roll body not making direct contact with the applicator roll.

6. The developer unit according to claim 5,
wherein
a predetermined electric potential is applied to the applicator roll.

7. The developer unit according to claim 2,
wherein
the toner particles are deposited on the individual fibres of the fibre coating of the developer roll and form a uniform toner flock there.

8. The developer unit according to claim 2,
wherein
to reduce the toner layer thickness, a metering roll is arranged on the developer roll, being arranged at a distance from the roll body of the developer roll which is less than the height of the fibres of the fibre coating projecting from the roll body, and the roll body not making direct contact with the metering roll.

9. The developer unit according to claim 8,
wherein
a predetermined electric potential is applied to the metering roll.

10. The developer unit according to claim 8,
wherein
in the direction of rotation of the developer roll, between the metering roll and the photoconductor, a toner charging corona applying an additional charge to the toner particles, is arranged on the developer roll.

11. An electrophotographic printing device for printing on glass or ceramic material comprising a developer unit according to claim 1.
